(19) United States
(12) Patent Application Publication
(10) Pub. No.: US 2006/0126699 A1
(43) Pub. Date: Jun. 15, 2006

(54) Optical element, method of manufacturing same, and optical apparatus using optical element

(76) Inventor: Yasushi Kaneda, Saitama-shi (JP)

Correspondence Address: MORGAN & FINNEGAN, L.L.P., 3 WORLD FINANCIAL CENTER, NEW YORK, NY, 10281-2101, US

(21) Appl. No.: 11/298,425

(22) Filed: Dec. 8, 2005

(30) Foreign Application Priority Data
Dec. 10, 2004 (JP) 2004-358594

(51) Int. Cl. H01S 3/08

(52) U.S. Cl. 372/102

(57) ABSTRACT

Grating portions made of a metal are arranged as a first layer at regular intervals on a substrate, and a filling material fills the space between adjacent ones of the grating portions. Also, as a second layer, only grating portions are likewise arranged at regular intervals on the filling material. Structures each comprising grating portions of a great pitch P are stacked one upon the other to thereby cause them to function as a deflecting plate having a small apparent pitch.

### BACKGROUND OF THE INVENTION

1. Field of the Invention

This invention relates to an optical element for use in an optical apparatus for spectroscopy, optical measurement, optical communication, etc., a method of manufacturing the same, and an optical apparatus using the optical element.

2. Related Background Art

The range of wavelength used in optical communication, optical measurement, etc. is sub μm to 2 μm.

If to light in this range of wavelength, an attempt is made to make the pitch P of a grating into 1/10, the pitch P must be made smaller than 0.2 μm, and apparatuses which can made it are restricted to EB and a semiconductor exposing apparatus of the newest type ArF.

The former is poor in productivity, and the latter is high in price and is also high in maintenance cost. Also, when a visible light range is taken into consideration, the grating is a grating having a pitch P of the order of 40 nm, and it is difficult to make it even by the use of the aforementioned EB.

### SUMMARY OF THE INVENTION

It is an object of the present invention to solve the above-noted problem, and to stack a grating of a rough pattern pitch while shifting the position thereof to thereby manufacture a grating apparently having a small pitch.

That is, it is an object of the present invention to provide an optical element which can improve the characteristic of a deflecting plate even by the use of a process of making a grating of a rough pitch, and a method of manufacturing the same.

In order to achieve the above object, a feature of the present invention is that an element for modulating the polarization of light is made into a periodical structure, which is stacked into two or more layers while the period of the periodical structure is shifted.

A further feature of the present invention is that an element for modulating the polarization of light is made into a periodical structure by the repetition of a dielectric material and an electrical conductor, and the periodical structure is slacked into two or more layers while the period of the periodical structure is shifted, and the dielectric material is etched with the electrical conductor as a mask.

Thus, according to the present invention, even if the pitch of a grating is rough, the apparent pitch becomes small by stacking and a polarization property can be improved.

### BRIEF DESCRIPTION OF THE DRAWINGS

FIG. 1 shows the construction of Embodiment 1.

FIG. 2 is a characteristic graph of a quenching ratio.

FIG. 3 shows the construction of Embodiment 2.

FIG. 4 is a characteristic graph of a quenching ratio.

FIG. 5 shows the construction of Embodiment 3.

FIG. 6 is a characteristic graph of a quenching ratio.

FIGS. 7A, 7B, 7C, 7D, 7E and 7F show the steps of a manufacturing process.

FIG. 8 shows the construction of Embodiment 4.

FIG. 9 is a characteristic graph of a quenching ratio.

### DETAILED DESCRIPTION OF THE PREFERRED EMBODIMENTS

The present invention will hereinafter be described in detail with respect to some embodiments thereof shown in the drawings.

### Embodiment 1

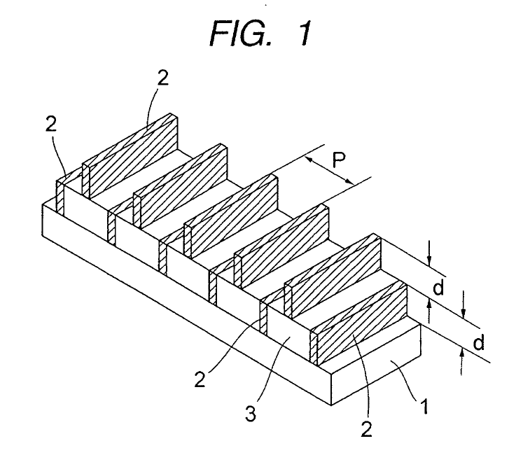

FIG. 1 shows the construction of a fine optical element according to Embodiment 1.

Grating portions 2 made of a metal are arranged as a first layer at regular intervals on a substrate 1, a filling material 3 fills the space between adjacent ones of the grating portions 2.

Also, as a second layer, only grating portions 2 are likewise arranged at regular intervals on the filling material 3.

When the pitch P of the grating portions 2 of a height d on the substrate 1 is selected to a value smaller than the wavelength λ of light used, the grating portions 2 function as deflecting plates.

When the pitch P of the grating portions 2 is sufficiently smaller than the wavelength λ, the function as the deflecting plates becomes best. However, it is still difficult by the actual machining technique.

So, by stacking a structure comprising grating portions 2 of a great pitch P, nearly the best performance is obtained.

In FIG. 1, the grating portions 2 are stacked. For example, the pitch P=0.26 μm and height d=150 nm of the grating portions 2 as the first layer, and the grating portions 2 as the second layer are disposed while being deviated by P/2 in the pitch direction with respect to the grating portions 2 as the first layer.

Al is used as the grating portions 2, SiO₂ is used as the filling material 3, and transparent synthetic quartz is used as the substrate 1.

FIG. 2 shows the result of simulation. Evaluation was effected by the use of RCWA. It can be seen from FIG. 2 that a structure of two layers leads to the obtainment of a deflecting plate better in quenching ratio γ. Here, the quenching ratio γ is defined by γ=10 Log₁₀(I_{TE}/I_{TM}), where I_{TE} is the element transmitted light intensity of TE wave (light having polarization in the same direction as the direction of the grating line), and I_{TM} is the element transmitted light intensity of TM wave (light having polarization in the same direction as the arrangement direction of the gratings).

Also, if the refractive index of the filling material 3 filling the space between adjacent ones of the grating portions 2 as the first layer is small, the quenching ratio γ becomes great.

In Embodiment 1, SiO₂has been described as an example of the filling material 3, but if it is replaced with film of MgF₂, there can be constructed a deflecting plate greater in quenching ratio γ.

This Embodiment 1 is very simple in construction, and is rough in pattern and therefore, can be manufactured even if use is not made of a manufacturing apparatus at the most advanced level. Also, when manufacture is effected by the use of a semiconductor process or the like, downsizing, higher accuracy, lower costs and mass production becomes possible.

By only the construction of the film of a periodical structure member alone, or by providing it on thin film, it is possible to obtain an optical element much better in efficiency than a conventional one.

### Embodiment 2

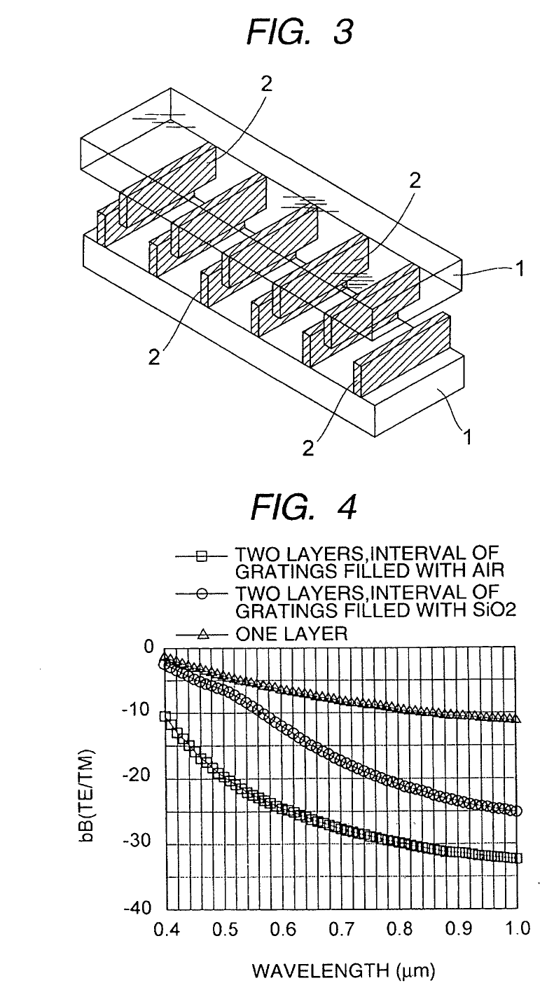

FIG. 3 shows the construction of an optical element according to Embodiment 2, and this construction is one in which two transparent substrates 1 to which grating portions 2 are fixed at regular intervals are fixed with the grating portions 2 fixed in opposed relationship with one another.

The principle of this Embodiment 2 is basically the same as that of Embodiment 1. Also, unlike Embodiment 1, the space between adjacent ones of the grating portions 2 as the first layer is filled with air which is small in refractive index, to thereby improve the quenching ratio γ.

If here, the pitch P of the grating portions 2 is 0.26 μm, and the height d of the grating portions 2 is 0.15 μm, and a feeling factor f is 0.15, such characteristic of the quenching ratio γ as shown in FIG. 4 is obtained as the result of the simulation of RCWA.

In FIG. 4, points indicated by triangles represent the characteristic of the quenching ratio γ of a conventional grid wire deflecting plate (the pitch P=0.26 μm, the height d of the grating=0.15 μm, the feeling factor f=0.3) relative to the wavelength when it has one layer of grating portions 2.

Also, points indicated by circles represent the characteristic of the quenching ratio γ of Embodiment 1, and points indicated by rectangles represent the characteristic of the quenching ratio γ of Embodiment 2.

If the space between adjacent ones of the grating portions 2 as the first layer is not filled with the filling material 3, it becomes difficult to form a structure in the upper portion thereof, but as shown in FIG. 3, two elements having only one layer of grating portions 2, and they are stacked one upon the other with the grating portions opposed to each other, whereby the manufacture of this structure becomes possible.

This Embodiment 2 has the following effects, in addition to the effect of Embodiment 1.

(1) The substance between adjacent ones of the grating portions 2 as the first layer is air or the like which is low in refractive index and therefore, the quenching ratio γ is good.

(2) The structures are manufactured and stuck together, whereby a stacked structure can be manufactures simply.

### Embodiment 3

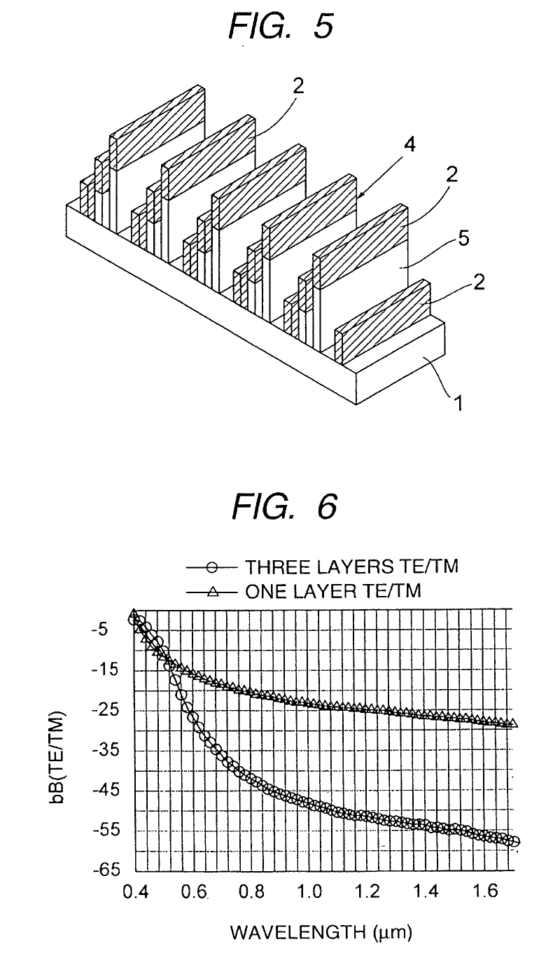

FIG. 5 shows the construction of an optical element according to Embodiment 3, in which on a substrate 1, there are arranged at regular intervals wall portions 4 provided with grating portions 2 on the uppermost portions thereof and having three kinds of heights.

Supporting portions 5 supporting the grating portions 2 are made of SiO₂.

Also, the wall portions 4 having three different heights are arranged in the order of the heights, and combinations of three wall portions 4 repeatedly arranged.

The principle of this Embodiment 3 is also basically the same as that of Embodiment 1. The other portions than the SiO₂ layers providing the supporting portions 5 under the grating portions 2 as the upper layer are air and therefore, the actual average refractive index becomes smaller than the refractive index of SiO₂. Therefore, the quenching ratio γ of the stacked structures is improved.

Here, the pitch P of the grating portions 2 is 0.26 μm, the height d of the grating portions 2 is 0.18 μm, the feeling factor f is 0.15, and three layers are provided as shown in FIG. 5. As the result of the simulation of RCWA, there is obtained such characteristic of the quenching ratio γ as shown in FIG. 6.

Triangles in FIG. 6 represent the characteristic of the quenching ratio γ of a conventional grid wire deflecting plate (the pitch P=0.26 μm, the height d of the grating=0.18 μm, the feeling factor f=0.3) relative to the wavelength, and points indicated by circles represent the characteristic of the quenching ratio γ of this Embodiment 3.

If the space between adjacent ones of the grating portions 2 as the first layer is not filled with the filling material, it becomes possible to form a structure thereon, but periodical structures each comprising three layers of grating portions 2 and the filling material 3 are stacked, and the filling material 3 of this stacked structure is etched until the substrate 1 appears, whereby this structure can be manufactured easily.

Also, Al and SiO₂ differ in the etchant when etched and therefore, the grating portions 2 in the Al portion can be caused to act as a mask when SiO₂ of the supporting portions 5 is etched.

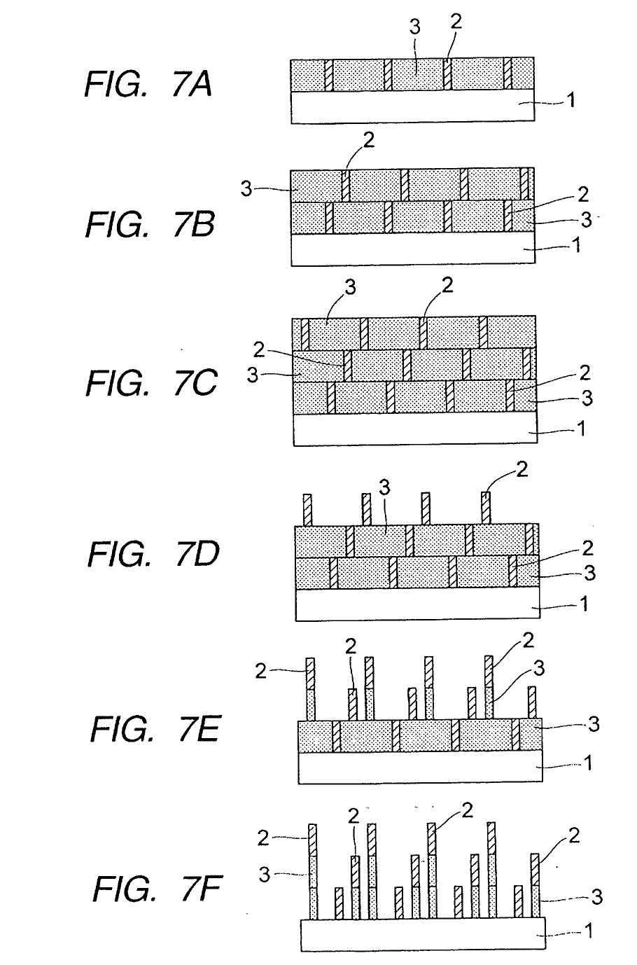

FIGS. 7A to 7F show this process, and in FIG. 7A, the pattern of the grating portions 2 by Al is made on the substrate 1, and the space between adjacent ones of these grating portions 2 is filled with the filling material 3 of SiO₂. In FIG. 7B, the pattern of the grating portions 2 is again made thereon, and the space between adjacent ones of these grating portions 2 is filled with the filling material 3. In FIG. 7C, the same step as that of FIG. 7B is repeated to thereby manufacture a three-layer stacked structure. In FIGS. 7D to 7D, a fluorine etchant is used and dry etching is effected on the filling material 3 with the grating portions 2 as a mask, whereupon finally, an optical element of the shape of FIG. 7F, i.e., the shape of FIG. 5 can be obtained.

This Embodiment 3 has the following effects, in addition to the effects of Embodiments 1 and 2.

(1) Embodiment 3 is of a simple construction, and if dry etching or the like is used, the final shape can be easily formed.

(2) Embodiment 3 is of e.g. a three-layer construction and therefore, the apparent pitch becomes fine, and there is obtained a deflecting plate having a good quenching ratio γ.

### Embodiment 4

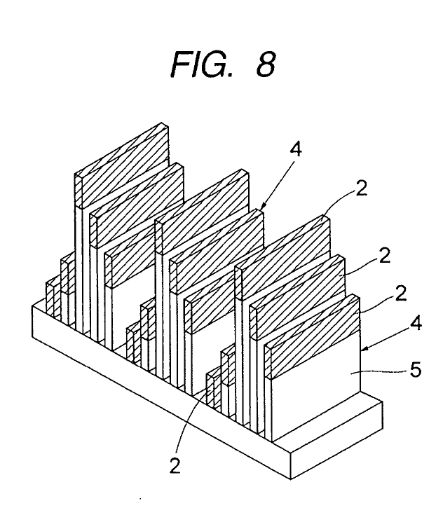

FIG. 8 shows the construction of an optical element according to Embodiment 4.

The structure of this Embodiment 4 is a fine-layer structure, and the manufacturing process thereof is the development of the process of Embodiment 3.

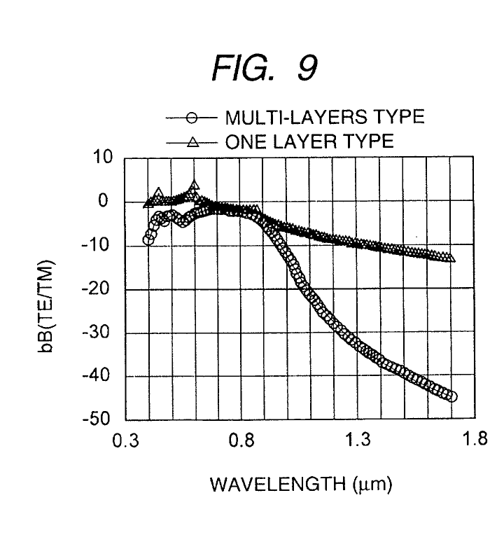

If here, the pitch P of the grating portions 2 is 0.6 μm, and the height d of the grating portions 2 is 0.18 μm, and the feeling factor f is 0.1, and five layers are made, such characteristic of the quenching ratio as shown in FIG. 9 is obtained as the result of the simulation of RCWA.

In FIG. 9, a line of circles indicates the characteristic of the quenching ratio γ of the structure of Embodiment 4, and a line of triangles indicates the characteristic of the quenching ratio γ of a grating of one layer having a pitch of 0.6 μm.

According to Embodiment 4, the quenching ratio γ is improved from a wavelength of the order of 0.9 μm, and in the range of 1.1 μm, there is shown a characteristic usable at efficiency of −20 dB or greater.

This Embodiment 4 has the following effects, in addition to the effects of the foregoing Embodiment 1, 2 and 3.

(1) Embodiment 4 is of a simple construction, and if dry etching or the like is used, the final shape can be simple formed.

(2) Embodiment 4 is of a five-layer construction and therefore, in spite of the pitch of one layer being greater than the wavelength, the apparent pitch becomes five, and it becomes possible to easily manufacture a deflecting plate having a good quenching ratio γ.

This application claims priority from Japanese Patent Application No. 2004-358594 filed on Dec. 10, 2004, which is hereby incorporated by reference herein.

What is claimed is:

1. An optical element including:
a substrate;
a first periodical grating formed on said substrate and having a polarization property; and
a second periodical grating shifted in position relative to said first periodical grating, and stacked on said first grating.

2. An optical element according to claim 1, wherein said first and second periodical gratings are disposed at regular intervals.

3. An optical element according to claim 1, the cross sections of said first and second periodical gratings are rectangular.

4. An optical element according to claim 1, wherein said first and second periodical gratins are formed of a metal material.

5. An optical element according to claim 1, wherein said first and second periodical gratins are constituted by the repetition of a dielectric material and an electrical conductor.

6. An optical element according to claim 1, wherein the periods of said first and second periodical elements are shorter than a wavelength used.

7. An optical apparatus using an optical element according to claim 1.

8. A method of manufacturing an optical element, including:
a first step of forming on a substrate an element for modulating the polarization of light as a first periodical structure by the repetition of a dielectric material and an electrical conductor;
a second step of stacking a second periodical structure on the periodical structure formed at said first step while shifting the period thereof,
the space between the dielectric material and dielectric material of each of said first and second periodical structures being filled with a filling material; and
a third step of etching said filling material with said electrical conductor as a mask.

9. An optical apparatus using an optical element according to claim 2.

10. An optical apparatus using an optical element according to claim 3.

11. An optical apparatus using an optical element according to claim 4.

12. An optical apparatus using an optical element according to claim 5.

13. An optical apparatus using an optical element according to claim 6.
